(19) United States
(12) Patent Application Publication
(10) Pub. No.: US 2011/0299712 A1
(43) Pub. Date: Dec. 8, 2011

(54) Cerumen Filter For A Hearing Aid

(75) Inventors: Martin Bondo, Vaerlose (DK); Christian Lyngsø Svejgaard, Roskilde (DK)

(73) Assignee: Sonion A/S, Roskilde (DK)

(21) Appl. No.: 13/155,107

(22) Filed: Jun. 7, 2011

Related U.S. Application Data
(60) Provisional application No. 61/352,261, filed on Jun. 7, 2010.

(51) Int. Cl. H04R 25/00

(52) U.S. Cl. 381/325

(57) ABSTRACT

A cerumen filter at least a part of which is adapted to be inserted into an opening of a hearing aid. The cerumen filter comprises a body defining an audio passage extending through the cerumen filter and a cerumen filter arrangement comprising an outer cerumen filter and an inner cerumen filter. The cerumen filter arrangement is arranged to prevent flow of cerumen into the audio passage.

### REFERENCE TO RELATED APPLICATIONS

This application claims the benefit of U.S. Provisional Patent Application Ser. No. 61/352,261, filed Jun. 7, 2010, and titled “A Cerumen Filter For A Hearing Aid,” which is incorporated herein in its entirety.

### FIELD OF THE INVENTION

The present invention relates to a cerumen filter for a hearing aid.

### BACKGROUND OF THE INVENTION

Hearing aids usually have a sound outlet port that is positioned in the ear of a user to deliver sound. To prevent the sound outlet port or connected tubing from being clogged by ear wax, it is known to provide an ear wax guard in the port or tubing. This further prevents ear wax from travelling through the tubing to the inner part of the hearing aid hampering or disabling the electro-acoustic transducer located therein. From U.S. Pat. No. 6,795,562, a pin shaped ear wax guard is known that is to be positioned with the stem into the outlet port. The ear wax guard has a T-shaped acoustic channel and a filter located therein. The T-shape provides a tortuous path that impedes ear wax from travelling through the guard. The filter blocks ear wax having a certain size or shape depending on the design of the filter. Over time the wax guard may get clogged—instead of the outlet port—and needs to be cleaned or replaced. In U.S. Pat. No. 6,105,713, a hearing aid is disclosed having a cover pivotally mounted in a recess of a tip portion of the hearing aid to cover the outlet port located in the tip portion. The cover pivots in a plane perpendicular to the outlet port. A grommet with a filter disposed therein is disposed in the outlet port. The tip portion is formed by an end plate that is fastened to the hearing aid. Though this facilitates removal of the grommet with filter, it also requires custom trimming of the end plate to match the profile of an ear canal of a user and a specific design corresponding to the hearing aid. In U.S. Pat. No. 6,795,562 and US 2004/0240694, wax guards are disclosed that allow complete removal and replacement without the necessity of performing custom trimming of an end plate or tip portion of an hearing aid. The wax guards are provided with elevations on the outer surface to keep them in position in the outlet port by frictional fitting. In addition, the wax guard of U.S. Pat. No. 6,795,562 is adapted to facilitate cooperation with a removal tool. This requires the filter to be positioned at an inner end of the acoustic channel of the wax guard to allow cooperation with the removal tool.

### DETAILED DESCRIPTION OF THE INVENTION

The present invention relates to a cerumen filter at least a part of which is adapted to be inserted into an opening of a hearing aid. The cerumen filter comprises a body and a cerumen filter. The body defines an audio passage extending through the cerumen filter. The cerumen filter arrangement comprises an outer cerumen filter and an inner cerumen filter. The cerumen filter arrangement is arranged to prevent flow of cerumen into the audio passage and, as such, inhibits or limits the flow of cerumen through the audio passage.

Relative to a cerumen filter comprising only one filter, the provision of two filters improves the filter's ability to filter away unwanted cerumen. This is desirable, especially as the two different filters may be adapted to filter away different kinds of cerumen.

In one embodiment, the body of the cerumen filter is adapted to be inserted into the opening of the hearing aid. An outer surface of the body may define one or more engagement surfaces for engagement with the hearing aid so as to retain the cerumen filter relative to hearing aid.

It will be appreciated that the body of the cerumen filter must be shaped such that it can be inserted into the opening. Accordingly, the cross-sectional shape of the body may, in some embodiments, be round/circular, oval or quadrangular.

In one embodiment, the total length of the cerumen filter is below 3 mm, such as below 2.5 mm, such as below 2 mm, such as below 1.5 mm, such as below 1 mm.

In one embodiment, the width of the cerumen filter is below 3 mm, such as below 2.5 mm, such as below 2 mm, such as below 1.5 mm, such as below 1 mm.

In one embodiment, the width of the body of the cerumen filter is below 2 mm, such as below 1.5 mm, such as below 1.25 mm, such as below 1 mm.

In one embodiment, the width (e.g. the diameter) of the lid is below 2 mm, such as below 1.8 mm, such as below 1.6 mm, such as below 1.4 mm, such as below 1.2 mm, such as below 1.0 mm.

In one embodiment, the length of the audio passage is below 2 mm, such as below 1.5 mm, such as below 1.0 mm.

The internal diameter of the audio passage of the body may be below 2 mm, such as below 1.5 mm, such as below 1.0 mm.

In one embodiment, the cerumen filter comprises a material that is more resilient than the material defining the opening into which the cerumen filter is to be inserted. As an example, the cerumen filter may comprise POM (Polyoxymethylene) and/or Polyamid (e.g. PA66 without reinforcement).

The opening of the hearing aid may be defined by a tube through which sound propagates during use of the hearing aid. When the sound propagates through the tube while the cerumen filter is inserted into said tube, the sound may continue its propagation through the audio passage of the body of the cerumen filter. This audio passage may be a substantially linear passage or may be curved. The audio passage may define an inner opening that, when the cerumen filter is inserted into the opening of the hearing aid, is located inside the opening of the hearing aid. Similarly, the audio passage may define an outer opening that, when the hearing aid is located in the opening of the hearing aid, is located outside the opening of the hearing aid.

The cerumen filter arrangement comprises an outer cerumen filter and an inner cerumen filter. The cerumen filter arrangement is arranged to prevent flow of cerumen into the audio passage from a position outside the cerumen filter and into the audio passage.

In one embodiment, the order of elements when the cerumen filter is inserted into the opening of the hearing aid is as follows: opening of hearing aid—inner opening of the audio passage—inner filter—outer filter—outer opening.

In an alternative embodiment, the order is as follows: opening of hearing aid—inner opening of the audio passage—inner filter—outer opening—outer filter.

In yet another embodiment, the order is as follows: opening of hearing aid—inner opening of the audio passage—outer opening—inner filter—outer filter.

Typically, the cerumen will travel from a position that is both outside the opening of the hearing aid and outside the audio passage, and into the audio passage and then further into the opening of the hearing aid. Both the inner and the outer filters may be arranged to prevent the cerumen from travelling along this path.

In one embodiment, more than two filters are provided, such as three filters, such as four filters, such as five filters, such as six filters. When three or more filters are provided an inner and an outer filter may be provided and, therebetween, one or more intermediate filters are provided.

The filters may be shaped such so as to prevent the cerumen from passing through the filter. Accordingly, one or more of the filters may in one embodiment form a grid-like structure defining holes that are large enough to allow the sound to propagate therethrough, while at the same time being small enough to prevent the cerumen from entering the audio passage, and thus the opening of the hearing aid. Alternatively, or as a supplement, one or more of the filters may form a surface which is adapted to cause the cerumen to adhere or stick to this surface and thus prevent the cerumen from passing further into the audio passage or into the opening of the hearing aid.

The inner filter may be adapted to filter away a first kind of cerumen and the second filter may be adapted to filter away a second kind of cerumen. Accordingly, in one embodiment, the outer cerumen filter is adapted to block the passage of cerumen of a first size, and the inner cerumen filter is adapted to block passage cerumen of a second size, the first size being larger than the second size. In the latter embodiment, the outer filter serves as a coarse filter while the inner filter serves as a fine filter.

In one embodiment, the two filters may be adapted to filter cerumen of different viscosity. Accordingly, the inner filter may be adapted to filter cerumen with a first viscosity, while the outer filter is adapted to filter cerumen with a second viscosity. In one embodiment, the first viscosity is lower than the second viscosity, while in other embodiments the first viscosity is higher than the second viscosity.

The first filter may be adapted to filter air born cerumen (typically in the form of air born oily matter), while the outer filter is adapted to filter non-air born cerumen (typically larger pieces of cerumen which is moved inside the ear by means of the ear cilia). Alternatively, the outer filter may be adapted to filter air born cerumen, while the inner filter is adapted to filter non-air born cerumen.

In one embodiment, the inner cerumen filter is located downstream relative to the outer cerumen filter with respect to a flow direction of cerumen from a position outside the cerumen filter and into the audio passage.

In one embodiment, the cerumen filter further comprises a lid that is pivotally connected to the body of the cerumen filter, such that the lid is movable between a closed position in which the outer cerumen filter covers at least at part of the inner cerumen filter, and an open position in which the lid does not cover the inner cerumen filter. By providing a lid which is movable between the closed and the open position, it is possible to mould an inner filter in a position which during use of the filter is located behind the outer filter. Normally such geometries are difficult—if not impossible—to manufacture. However by moulding the cerumen filter with the lid in its open position, the formation of the inner filter is possible. Subsequent to the moulding process, the lid is closed whereby the outer filter is defined.

In order to retain the lid in its closed position, the body and the lid may each comprise retaining geometries which are arranged such that when the lid is in its closed position, the retaining surfaces engage each other whereby the lid is retained in its closed position relative to the body. In one embodiment, the retaining surfaces define a snap lock which allows the lid to be permanently or detachably connected to remainder of the cerumen filter. Alternatively, or as a supplement, the lid may be glued or welded to the body of the cerumen filter.

The outer cerumen filter may be defined between the lid and the body when the lid is in its closed position. Accordingly, the outer cerumen filter may be defined by at least one space/passage defined between the lid and the body, when the outer cerumen filter is in its closed position. In one embodiment, at least two spaces/passages are defined between the lid and the body when the lid is in its closed position, such as three, such as four, such as five, such as six, such as seven, such as eight, such as nine, such as ten, such as above ten.

In one embodiment, the spaces/passages defined between the lid and the body are of different sizes. In one embodiment, a first group of passages have a first size while a second group of passages have a second size. The first size is different from the second size. Alternatively, or as a supplement, the lid may define the outer cerumen filter.

In one embodiment, at least a part of one of the inner and the outer filter defines a plane surface. As an example, the entire inner filter may be plane and/or the entire outer filter may be plane.

In another embodiment, at least one of the outer and the inner cerumen filters defines a concave filter surface, i.e. such that at least a part of the respective filter(s) extend(s) into the cerumen filter. In an alternative embodiment, at least one of the outer and the inner cerumen filters defines a convex filter surface, i.e. such that at least a part of the respective filter(s) extend(s) in a direction away from the cerumen filter. At least one of the inner and the outer filters may be dome shaped.

In one embodiment, the area of all the openings of one of the inner and the outer filters is larger than or equal to the cross-sectional area of the audio passage. Alternatively, said area of all the openings may be 90 percent of the cross-sectional area of the audio passage, 80 percent, 70 percent, 60 percent, 50 percent, 110 percent, 120 percent, 130 percent, 140 percent, 150 percent.

As the cerumen filter is very small (often the longest dimension of the filter is shorter than 2 mm) it is difficult if not impossible to insert or remove the filter by hand. Thus, the cerumen filter may comprise a locking geometry for locking a retraction element to the cerumen filter so as to allow the cerumen filter to be retracted from the opening by means of the retraction element. The retraction element may define a geometry that corresponds to the locking geometry, such that insertion of geometry of the retraction element into the locking geometry causes the retraction element to be permanently or detachably attached to the cerumen filter. When the retraction element is attached to the cerumen filter, the filter may be inserted into or removed from the opening of the hearing aid.

In one embodiment, the locking geometry is defined on a side/lateral surface of the cerumen filter. Alternatively, or as a supplement, the locking geometry may be defined by the lid.

In one embodiment, the outer and/or the inner cerumen filter are moulded as separate elements that are inserted into or attached to the body of the cerumen filter. As an example, the inner filter may be adapted to be slidingly moved into the audio passage of the cerumen filter.

In a second aspect, the present invention relates to a hearing aid system comprising the cerumen filter according to the invention set forth above relative to the first aspect. The hearing aid system would include a microphone for receiving sound and a receiver for producing acoustic signals to be transmitted toward a patient's eardrum.

### BRIEF DESCRIPTION OF THE FIGURES

The invention will now be described with reference to the figures in which:

FIGS. 1-5 disclose the cerumen filter with the lid in its closed position.

FIG. 6 discloses a cross-section of the cerumen filter with lid in its closed position; and

FIGS. 7-8 disclose the cerumen filter with the lid in its open position.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE FIGURES

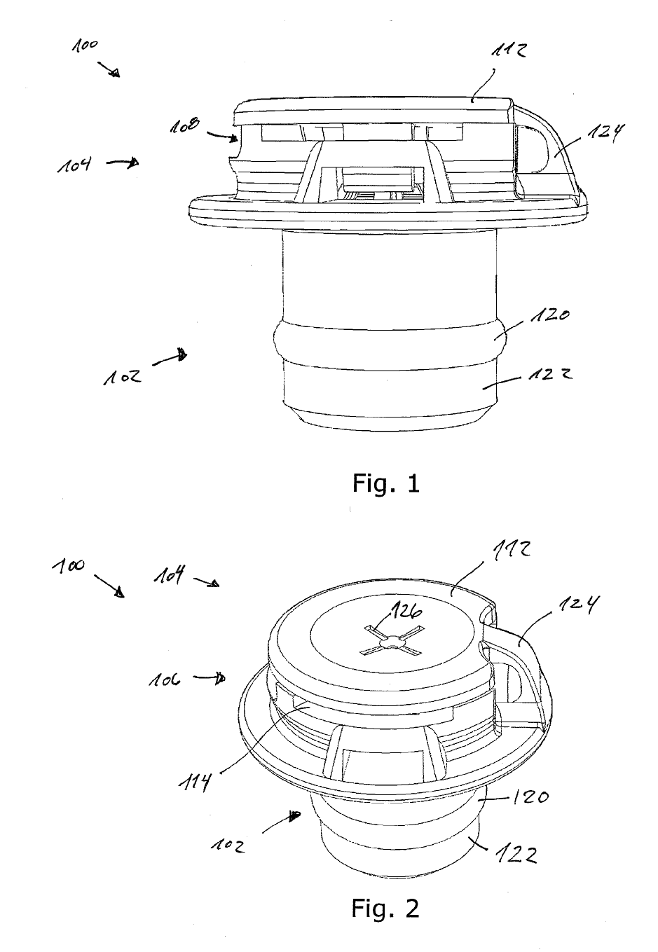

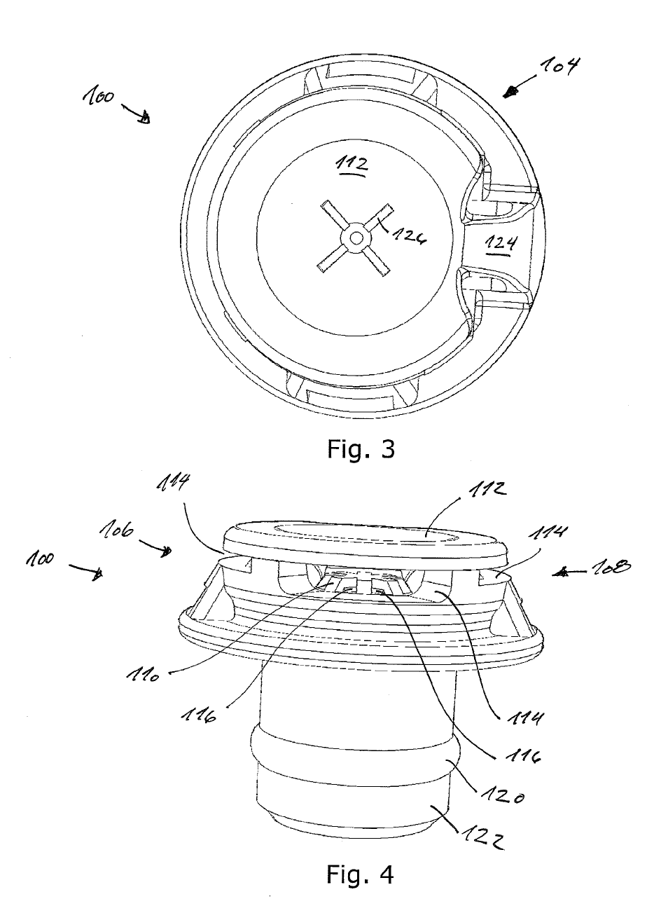

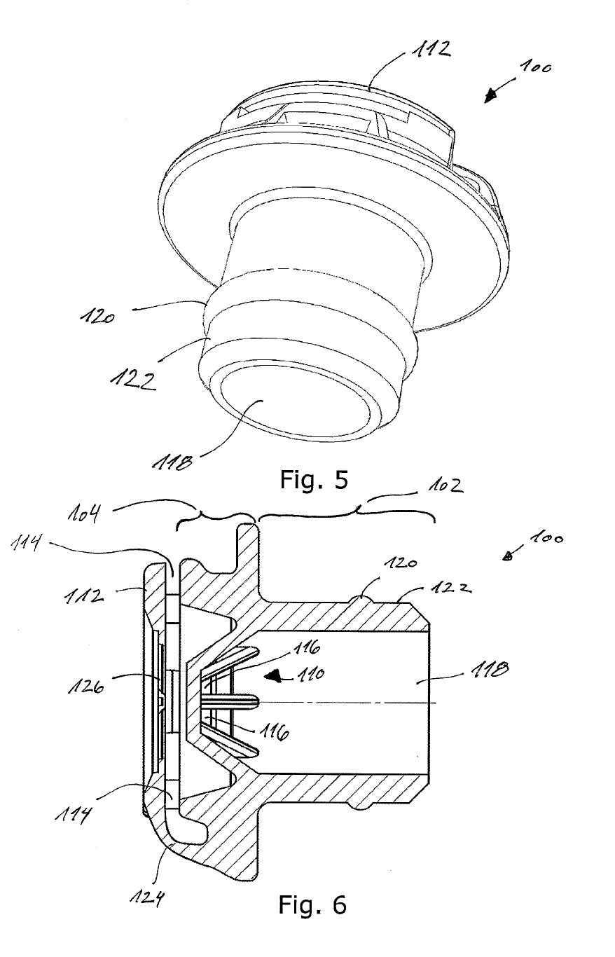

FIGS. 1-8 disclose a cerumen filter 100 comprising a body 102 and a head 104. The head 104 comprises a filter arrangement 106 forming an outer cerumen filter 108 and an inner cerumen filter 110. The outer cerumen filter 108 is defined between the head 104 and a lid 112. Accordingly, passages 114 defined between the head 104 and the lid 112 form openings in the outer cerumen filter 108. It will be appreciated that the smaller these passages 114 are, the smaller the pieces of cerumen are that will be filtered away by means of the outer cerumen filter 108.

Below the lid 112, the inner cerumen filter 110 is provided. Additionally, passages 116 are defined in the inner cerumen filter 110, and again the size of these passages 116 determines the size of the cerumen that may pass through the inner cerumen filter 110. In the embodiment of the figures, the inner cerumen filter 110 is convex and dome shaped such that the dome extends towards the lid 112. By providing a dome-shaped filter, larger passages 116 can be provided, whereby the filter will allow sound to propagate through the filter more easily.

The body 102 defines an audio passage 118 allowing sound to propagate from the opening (not shown) of the hearing aid (also not shown) and through the cerumen filter 100 and subsequently exit the cerumen filter 100 through the outer cerumen filter 108. However, the cerumen filter 100 prevents the flow of cerumen into the audio passage, i.e., it inhibits or limits the flow of cerumen within the audio passage.

An engagement surface 120 is provided on the outer surface 122 of the body 102. When the cerumen filter 100 is inserted into the opening of the hearing aid, the engagement surface 120 causes the cerumen filter 100 to be retained in the opening.

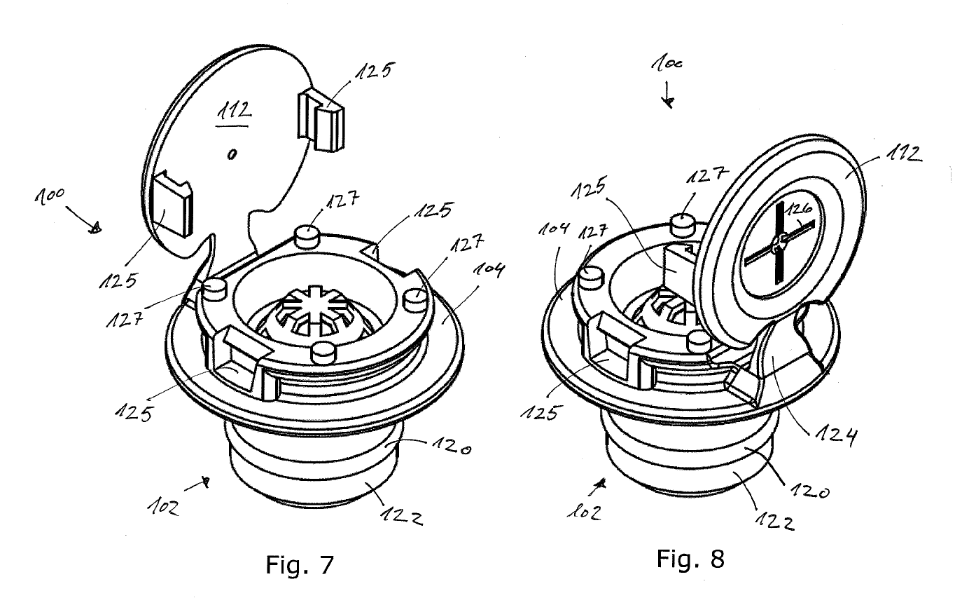

The lid 112 is pivotally connected to the head 104 by means of a pivotal connection 124. Due to the provision of the pivotal connection 124, the lid 112 is movable between the closed position shown in FIGS. 1-6, and the open position shown in FIGS. 7 and 8. During manufacture, the cerumen filter 100 is injection moulded in the shape shown in FIGS. 7 and 8. This enables the formation of the inner cerumen filter 110, as the lid 112 does not cover the location of the inner cerumen filter 110. After the moulding process or as a final step thereof, the lid 112 is moved into the closed position (see FIGS. 1-6), whereby the outer cerumen filter 108 is formed between the head 104 and the lid 112. The passages 114 between the head 104 and the lid 112 may be of different sizes. In one embodiment, each passage 114 in a first group of the passages has a first size, and each passage 114 in a second group of passages 114 has a second size. The first size may be larger than the second size.

The lid 112 and the head 104 are provided with a snap lock 125 which is adapted to lock the lid 112 in the closed position. Moreover, space-defining elements 127 are provided for spacing the lid 112 apart from the head 104 such that the passages 114 of the outer cerumen filter 108 are defined.

In order to facilitate insertion and/or removal of the cerumen filter 100 into the opening of the hearing aid, the lid 112 may be provided with a locking geometry 126 for temporarily locking a retraction element (not shown) to the cerumen filter so as to allow the cerumen filter 100 to be retracted or inserted from/into the opening of the hearing aid, by means of the retraction element. The cerumen filter 100 is used within a hearing aid system that includes a microphone for receiving sound from the ambient environment and a receiver for producing acoustic signals to be transmitted toward a patient's eardrum.

Each of these embodiments and obvious variations thereof is contemplated as falling within the spirit and scope of the claimed invention, which is set forth in the following claims.

1. A cerumen filter at least a part of which is adapted to be inserted into an opening of a hearing aid, the cerumen filter comprising:
a body defining an audio passage extending through the cerumen filter; and
a cerumen filter arrangement comprising an outer cerumen filter and an inner cerumen filter, the cerumen filter arrangement being arranged to prevent flow of cerumen into the audio passage.

2. A cerumen filter according to claim 1, wherein the outer cerumen filter is adapted to block the passage of cerumen of a first size, and wherein the inner cerumen filter is adapted to block passage cerumen of a second size, the first size being larger than the second size.

3. A cerumen filter according to claim 2, wherein the inner cerumen filter is located downstream relative to the outer cerumen filter with respect to a flow direction of cerumen from a position outside the cerumen filter and into the audio passage.

4. A cerumen filter according to claim 1, wherein the inner cerumen filter is located downstream relative to the outer cerumen filter with respect to a flow direction of cerumen from a position outside the cerumen filter and into the audio passage.

5. A cerumen filter according to claim 1, further comprising a locking geometry for locking a retraction element to the cerumen filter so as to allow the cerumen filter to be retracted from the opening by the retraction element.

6. A cerumen filter according to claim 1, wherein at least one of the outer and the inner cerumen filters defines a concave filter surface.

7. A cerumen filter according to claim 1, wherein at least one of the outer and the inner cerumen filters defines a convex filter surface.

8. A cerumen filter according to claim 1, further including a lid that is movable between a closed position and an opened position, the lid at least partially defining the outer cerumen filter in the closed position and providing access to the inner cerumen filter in the opened position.

9. A cerumen filter for use with a hearing aid, comprising:
a body defining an audio passage extending through the cerumen filter;
a cerumen filter arrangement adjacent to the body and comprising an outer cerumen filter and an inner cerumen filter, the cerumen filter arrangement for preventing flow of cerumen into the audio passage; and
a lid pivotally connected to the body, the lid being movable between a closed position in which the outer cerumen filter covers at least at part of the inner cerumen filter and an open position in which the lid does not cover the inner cerumen filter.

10. A cerumen filter according to claim 9, wherein the body and the lid each comprise retaining geometries which are arranged such that when the lid is in its closed position, the retaining surfaces engage each other whereby the lid is retained in its closed position relative to the body.

11. A cerumen filter according to claim 10, wherein the outer cerumen filter is defined by at least one space defined between the lid and the body when the outer cerumen filter is in its closed position.

12. A cerumen filter according to claim 9, wherein the outer cerumen filter is defined by at least one space defined between the lid and the body when the outer cerumen filter is in its closed position.

13. A cerumen filter according to claim 9, wherein at least one of the outer and the inner cerumen filters defines a concave filter surface.

14. A cerumen filter according to claim 9, wherein at least one of the outer and the inner cerumen filters defines a convex filter surface.

15. A cerumen filter according to claim 9, further comprising a locking geometry for locking a retraction element to the cerumen filter so as to allow the cerumen filter to be retracted from an opening in the hearing aid by use of the retraction element.

16. A cerumen filter according to claim 15, wherein the locking geometry is defined by the lid.

17. A hearing aid system, comprising:
a microphone for receiving sound;
a receiver for producing acoustic signals to be transmitted toward a patient's eardrum; and
a cerumen filter comprising a cerumen filter arrangement and a body defining an audio passage extending through the cerumen filter, the cerumen filter arrangement comprising an outer cerumen filter and an inner cerumen filter, the cerumen filter arrangement for preventing flow of cerumen into the audio passage.

18. A hearing aid according to claim 17, wherein the outer cerumen filter is adapted to block the passage of cerumen of a first size, and wherein the inner cerumen filter is adapted to block passage cerumen of a second size, the first size being larger than the second size.

19. A hearing aid according to claim 18, wherein the inner cerumen filter is located downstream relative to the outer cerumen filter with respect to a flow direction of cerumen from a position outside the cerumen filter and into the audio passage.

20. A hearing aid according to claim 17, further including a lid pivotally connected to the body, the lid being movable between a closed position in which the outer cerumen filter covers at least at part of the inner cerumen filter and an open position in which the lid does not cover the inner cerumen filter.
